(19) United States
(12) Patent Application Publication
(10) Pub. No.: US 2004/0049567 A1
(43) Pub. Date: Mar. 11, 2004

(54) Method for identifying the network location of a computer connected to a computer network

(76) Inventor: Paul Manchin, Queensland (AU)

Correspondence Address: Glenn Patent Group, 3475 Edison Way, Suite L, Menlo Park, CA, 94025, US

(21) Appl. No.: 10/416,865

(22) PCT Filed: Nov. 16, 2001
(86) PCT No.: PCT/AU01/01490

(30) Foreign Application Priority Data
Nov. 16, 2000 (AU) 71641/00
Jan. 23, 2001 (AU) PR 2674

(51) Int. Cl. G06F 15/173

(52) U.S. Cl. 709/223

(57) ABSTRACT

A method for identifying the network location of computers connected to a computer network. The method includes the steps of installing a software program on the computer which determines computer identification codes and network location addresses for the computer and transmits the codes and addresses to a central service location. The software continues to transmit the codes and addresses after the computer is reconnected to the network. Where the network location addresses are not instructive in identifying the network location of the computer the software program can invoke a tracing function to obtain alternative network location addresses. The network location addresses are then available to the owner of the computer from the central service location.

### FIELD OF THE INVENTION

The present invention is concerned with a method for identifying the network location of a computer that is connected to a computer network. The invention finds particular application in aiding in the recovery of misappropriated Internet capable computers.

### BACKGROUND TO THE INVENTION

Most personal computers are now manufactured to include software and hardware to enable connection to a computer network such as the Internet.

Such computers are relatively expensive articles. Furthermore over recent years personal computers have become more compact and increasingly susceptible to theft. Theft is particularly a problem where lap-top computers and personal digital assistants are concerned.

In the past certain methods have been used to reduce the likelihood of theft and to increase the probability of recovering stolen computers. Such methods have included the use of anti-theft devices such as high-strength cables securing the computer chassis to an office fixture. Other methods have related to the use of operating system software requiring the entry of a particular password in order to operate the computer so that the computer is inoperable without the password.

Etching of serial numbers or names identifying the owner of the computer onto its chassis has also been used to aid in post theft recovery.

Unfortunately none of the above approaches has been particularly successful and computer theft continues to be a problem. Clearly an alternatively approach is required.

### SUMMARY OF INVENTION

According to a first aspect of the present invention, there is provided a method for determining the network location of a plurality of user computers connected to a computer network, the method including the steps of:

making available for installation on each of said user computers a software product including:

location instructions for determining at least one computer identification code and at least one network location address of the user computer;

logging instructions for generating a log of said at least one computer identification code and network location address;

comparison instructions for comparing the log to current network location addresses associated with a further connection to the computer network; and

transmission instructions for transmitting the computer identification code and the current network location address to a central service location in the event of a discrepancy between the log and the current network location address;

maintaining a record of network location addresses and computer identification codes transmitted to the central service location for each user computer; and

providing from the central service location at least one network location address in response to a search key submitted by a user.

The computer network may include a local area network, a wide area network, or the Internet.

The method is applicable to any computer or digital device that has network connectivity such as a personal computer, a laptop computer or a personal digital assistant.

The computer identification code utilised by the method of the present invention may be any identifier that uniquely identifies the computer. The computer identification code could, for example include a manufacturer's serial number, a network adaptor identifier, and a unique identification code allocated to the installed software product.

The network location address utilised by the method of the present invention may include a local IP address, a router IP address, an IP address on data packet, an ISP user name, an ISP password, an ISP connection telephone number or a user telephone number.

The central service location may be any remote node which is accessible to the user computer via the computer network. The central service location may for example, be a host computer functioning as a web server.

The search key may include a user password related in the record to the computer identification code.

The transmission instructions may also transmit the time and date of the current connection to the computer network along with the computer identification codes and network location addresses. This allows a user to obtain more detailed information from the central service location in respect of their computer.

The software product may also include:

recognition instructions for recognising if the network location address determined by the location instructions is not indicative of the network location of the user computer; and

tracing instructions for generating a list of network location addresses of hosts visited by a network packet enroute from said user computer to a specified destination host, and wherein said list is transmitted by the transmission instructions with the computer identification codes to the central service location.

The destination host may be the central service location.

According to a second aspect of the present invention there is provided a software product stored upon a computer readable medium for execution by a computer, the software product including:

location instructions for determining at least one computer identification code and at least one network location address for the computer when connected to a computer network;

logging instructions for generating a log of said at least one computer identification code and the network location address;

comparison instructions for comparing the log to current network location addresses associated with a further connection to the computer network; and

transmission instructions for transmitting the computer identification codes and network location addresses to a central service location in the event of a discrepancy between the log and the current network location addresses.

The computer network may include a local area network, a wide area network or the Internet.

The software product of the present invention may be utilised on any computer or digital device that has network connectivity, such as a personal computer, a laptop computer or a personal digital assistant.

The computer identification code of the present invention may be any identifier that uniquely identifies the computer, such as a manufacturers serial number, a network adaptor identifier, or a unique identification code allocated to the software product.

The network location address may include a local IP address, a router IP address, an IP address on data packet, an ISP user name, an ISP password, an ISP connection telephone number, or a user telephone number.

The central service location of the present invention may be any remote node which is accessible to the computer via the computer network. The central service location may for example, be a host computer functioning as a web server.

The transmission instructions also transmit the time and date of the current connection to the computer network to the central service location.

The software product may also include:

recognition instructions for recognising if the network location address determined by the location instructions is not indicative of the network location of the computer; and

tracing instructions for generating a list of network location addresses of hosts visited by a network packet enroute from said computer to a specified destination host, and wherein said list is transmitted by the transmission instructions with the computer identification codes to the central service location.

The destination host may be the central service location.

According to a third aspect of the current invention there is provided a method of determining the network location of a plurality of user computers connected to a computer network, the method including the steps of:

making available for installation on each of said user computers a software product including:

identification instructions for determining at least one computer identification code of the user computer;

tracing instructions for generating a list of network location addresses of hosts visited by a network packet enroute from said user computer to a specified destination host; and

transmission instructions for transmitting the computer identification codes and said network location address list to a central service location;

maintaining a record of network location addresses and computer identification codes transmitted to the central service location for each user computer; and

providing from the central service location at least one network location address in response to a search key submitted by a user.

The computer network may include a local area network, a wide area network or the Internet.

The method is applicable to any computer or digital device that has network connectivity such as a personal computer, a laptop computer or a personal digital assistant.

The computer identification code utilised by the method of the present invention may be any identifier that uniquely identifies the computer. The computer identification code could, for example, include a manufacturers serial number, a network adaptor identifier, or a unique identification code allocated to the software product.

The network location addresses generated by the tracing instructions may be IP addresses, and the destination host may be the central service location. The central service location may be any remote node which is accessible to the user computer via the computer network. The central service location may, for example, be a host computer functioning as a web server.

The search key may include a user password related in the record to the computer identification code.

According to a fourth aspect of the present invention there is provided a software product stored upon a computer readable medium for execution by a computer, the software product including:

the identification instructions for determining at least one computer identification code for the computer;

tracing instructions for generating a list of network location addresses of hosts visited by a network packet enroute from the computer to a specified destination host when the computer is connected to a computer network;

transmission instructions for transmitting the computer identification codes and said network location address list to a central service location.

The software product may also include:

logging instructions for generating a log of said computer identification codes an network location addresses; and

comparison instructions for comparing the log to current network location addresses associated with a further connection to the computer network and for diverting control to the transmission instructions in the event that a discrepancy between the log and current network location address is detected.

The computer network may include a local area network a wide area network or the Internet.

The software product may be utilised on any computer or digital device that has network connectivity, such as a personal computer, a laptop computer or a personal digital assistant.

The computer identification code may be any identifier that uniquely identifies the computer. The computer identification code could, for example, include a manufacturers serial number, a network adaptor identifier or a unique identification code allocated to the software product.

The network location addresses generated by the tracing instructions may be an IP address, and the destination host may be the central service location. The central service location may be any remote node which is accessible to the computer via the computer network. The central service location may for example be a host computer functioning as a web server.

### BRIEF DESCRIPTION OF THE FIGURES

Preferred embodiments of the present invention will now be described, by way of example only, with reference to the attached Figures, wherein:

FIG. 1 is a schematic diagram depicting the various parties and equipment involved in making a connection to the Internet via an Internet Service Provider as occurs in the prior art.

FIG. 2 is a schematic diagram of a typical interface presented to a user by modem software when establishing a connection with an Internet Service Provider.

FIG. 3 is a schematic diagram depicting various identifiers associated with a computer when connected at a first location to the Internet as occurs in the prior art.

FIG. 4 is a schematic diagram depicting various identifiers associated with a computer when connected at a second location to the Internet as occurs in the prior art.

FIG. 5 is a schematic diagram depicting other identifiers associated with a computer when connected at a first location to the Internet.

FIG. 6 is a schematic diagram depicting other identifiers associated with a computer when connected to at a second location to the Internet.

FIG. 7 is a schematic diagram of a system for practising a method according to an embodiment of the present invention.

FIG. 8 is a flowchart of further steps used in performing a method according to an embodiment of the present invention.

FIG. 9 is a flowchart of steps used in performing a method according to an embodiment of the present invention.

### DETAILED DESCRIPTION OF THE EMBODIMENTS

Modern personal computers are manufactured according to various industry standards. These hardware standards allow individual computers to be identified, such as through the:

i) Manufacturer Serial Number (MSN):

The manufacturer's serial number is a permanent and unique number inserted into ROM on the motherboard of each computer. The MSN is independent of any operating system or software loaded onto the computer.

ii) Network Adaptor Identifier (NAI):

Each personal computer with computer network connectivity capability includes a network adaptor card, or equivalent having a unique 48-bit identification number which may be read remotely over a computer network. The network adaptor card is responsible for sending and receiving data frames to and from a computer network.

iii) Software ID Number (ID NUMBER)

It is also common practice for vendors of commercial software packages to allocate a unique number or other identifier to each copy of the software.

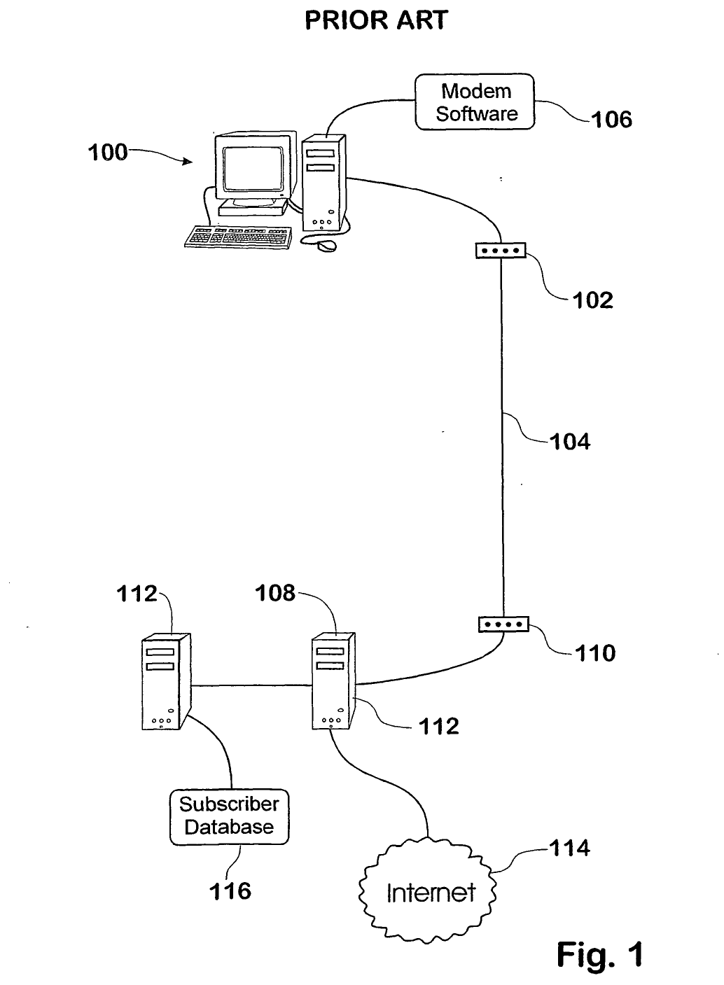

Most personal computers are used to gain access to the Internet and the access may be provided by an Internet Service Provider (ISP). An ISP can be a commercial entity that provides access to the Internet on a paid subscription basis. The various entities and equipment involved in a typical Internet connection is described by reference to FIG. 1.

The user of the personal computer 100 has a modem 102 connected to or installed in the computer 100. The modem is also connected to the user's external telephone line 104. The function of the modem is to convert electronic signals from the format used by the computer to a format that can be sent along a telephone line. Similarly, the modem receives signals from the telephone line sent by another modem and converts them back to the format used by the computer. The operation of the modem is controlled by modem software 106 installed on the computer 100.

To make a connection to an ISP 108 the modem software 106 instructs the modem 102 to dial one of the connection numbers of the modems 110 operated by the ISP 108. An ISP may provide alternative connection numbers, which allow connections to the ISP through different numbers, particularly if the primary number is engaged. In practice an ISP will maintain numerous modems to accommodate all of the subscribers to that ISP's service.

The various connection numbers are provided to the user upon becoming a subscriber to the ISP. The actual process of connection is similar to making a conventional telephone call and is well known in the art. Once a connection has been made a suitable protocol such as the serial line Internet protocol may allow the user's personal computer to become a remote node on the network and is therefore allocated its own IP address. The use of this address by the present invention is discussed below. The ISP's modems 110 are connected to special purpose computers 112 which are used to connect the ISP to the Internet 114. The special purpose computers are usually connected to a local area network (not shown) which in turn is connected to a larger network via a router (not shown). It is this arrangement of interconnected networks that forms the Internet 114. Again, the use of these computers by an ISP is well known in the art and an explanation is unnecessary to describe the present invention.

Upon a successful connection to the ISP's modem 110 and computers 112 an Internet connection is established with data packets passing to and from the user's computer 100 via the user's telephone line 104 as if the users computer was a node on the same network as the ISP's computers 112.

Hence it can be seen that when a personal computer is connected to the Internet it has associated with it the following network location addresses, namely:

1) Local IP Address (LIPA):

The local IP Address is the local area network unique address that is assigned to each computer on a network. The LIPA may be fixed or dynamically served from a router or similar device. As noted above most Internet service providers connect subscribers to the Internet by making them a remote node on the LAN. The Dynamic Host Configuration Protocol (DHCP) may be used by ISP's to assign a local IP Address to each user as they log on to the LAN. Other large organisations also use this protocol on their internal networks. Consequently the local IP Address may be different each time a connection is established.

2) Router IP Address (RIPA):

As noted above the special purpose computers of the ISP are connected to the Internet. This connection is usually by way of a router which has its own IP address. A router address is fixed and is assigned its IP Address according to its node in the network tree. The RIPA can be traced and is usually geographically locatable.

3) IP Address on Data Packet (IPADP)

This address is the IP address of the last router that passed a corresponding data packet to its destination computer. The IPADP may differ from the Router IP Address that the computer transmitting the data packet can see. This difference is usually a result of proxy servers or firewalls used to protect a LAN from data emanating from a Wide Area Network (WAN).

4) Date and Time

The date and time of connection to the Internet may be recorded at log on.

It will be noted from the above that each host network or host computer connected to the Internet is assigned a unique identifier called an IP Address which is used to route data packets to and from that host. Depending on the type of computer or network and also on how that computer or network is connected to the Internet the IP Address can either be fixed or can vary each time the computer or network makes a connection to the Internet. Also a computer or network can have another computer interposed between it and the direct connection to the Internet with that computer being referred to as a Proxy Server or in some cases a Firewall. The Proxy Server will also have its own IP Address.

The IP Address is a 32 bit binary number, but is usually represented using dotted decimal notation by four decimal numbers separated by decimal points. The IP Address has two parts namely the Network ID and the Host ID. The Network ID can be identified by the first, second or third groups of decimal numbers, depending upon the network class and the remaining decimal numbers identify the Host ID.

The IP address allocated to a user when connecting to the Internet will partly depend on the network ID of the ISP. Each subscriber to an ISP is also provided with an account for billing purposes. Subscribers are usually billed according to the length of Internet connections and/or the volume of data downloaded from the Internet. The ISP will usually maintain a database of subscribers and their accounts 116, along with other details such as the length of each Internet connection made by a subscriber. The ISP will also record certain personal details of its subscribers, such as their name, address, telephone number and credit card number.

In order to access their particular account an ISP will provide each subscriber with a user name and password. As also noted above, the ISP will also provide one or more telephone numbers for the users modem to dial to connect to the ISP's modems. It has also become common practice for ISPs to insist that subscribers provide their home telephone number to the ISP along with their user name and password when establishing a connection. This is insisted upon by ISPs to guard against unauthorised use being made of subscribers' accounts. Such unauthorised use of an ISP's resources cannot be billed back to the user. The ISP compares the received telephone number with the number recorded for that subscriber in its own records.

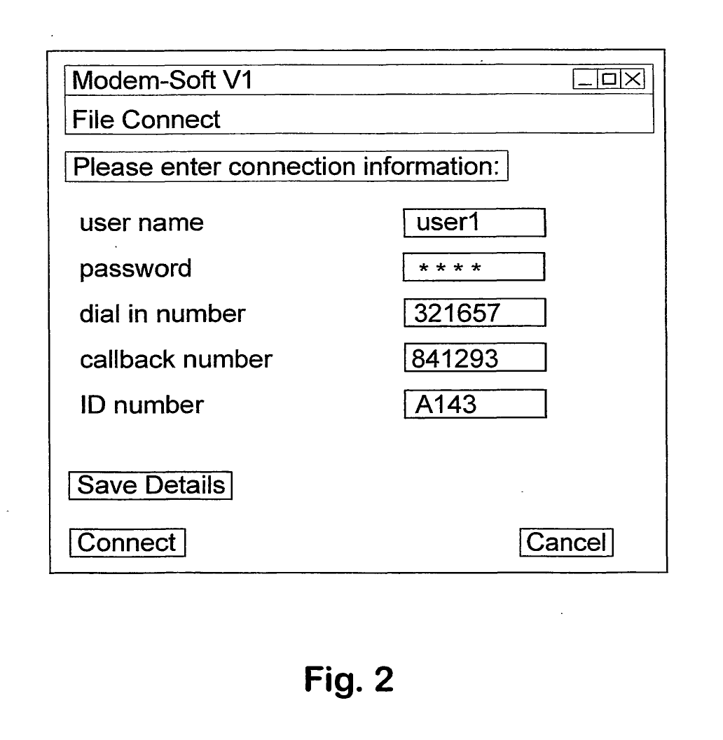

A basic interface presented to the user by the modem software is illustrated in FIG. 2. Upon entry of the relevant information, the software instructs the modem to dial the telephone number and establish a connection. As part of establishing the connection, the information entered by the user will be forwarded to the ISP's modem via the telephone line.

Typically, the above information is entered by the user upon their initial connection to the Internet via the ISP. The information is then saved by the modem software in a file on the user's computer. The file is generally saved as a hidden operating system file and can be saved in an encrypted format. The saving of the information relieves the user from re-entering it each time a connection to the Internet is made. It also allows a user to open a program such as a web browser directly which in turn instructs the modem software to make the connection. The user can also change the connection details if required such as when a new password is chosen, or if the user decides to use a different ISP with a different connection number. The saved file would also be updated.

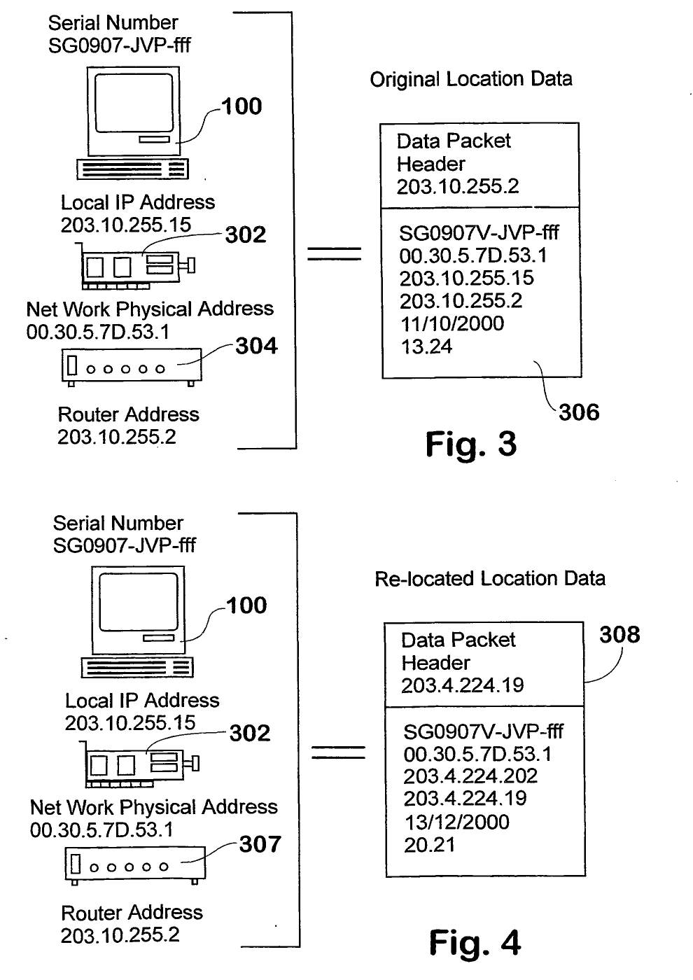

With reference to FIG. 3, a computer 100 incorporates a network adaptor card, is assigned a Local IP Address and is eventually connected to a router 304. The computer identification codes and network location addresses associated with the computer are as shown in FIG. 3. The identifiers may be collected to form a record 306 as shown.

Suppose now that computer 100 is disconnected and moved to another remote location where it is reconnected to the Internet. In that case the computer may have associated with it the computer identification codes and network location addresses e.g., as shown in FIG. 4. It will be noted that while the computer identification codes, i.e. the manufacturer's serial number and adaptor card number, have not changed, the network location addresses, i.e., the Local IP Address, the IP Address on Data Packet and Router address have indeed changed. Consequently the data record 308 associated with the computer when connected at the new location, contains some fields having values that differ from record 306 of FIG. 3. As will be explained, the present invention records changes such as those reflected in the differences between record 306 and record 308 in order to provide information on the computer's present network location.

In a similar way it will be noted that each subscriber to the ISP is uniquely identifiable, namely by the user's:

user name;

password;

modem connection number;

alternative connection number (if provided);

phone number;

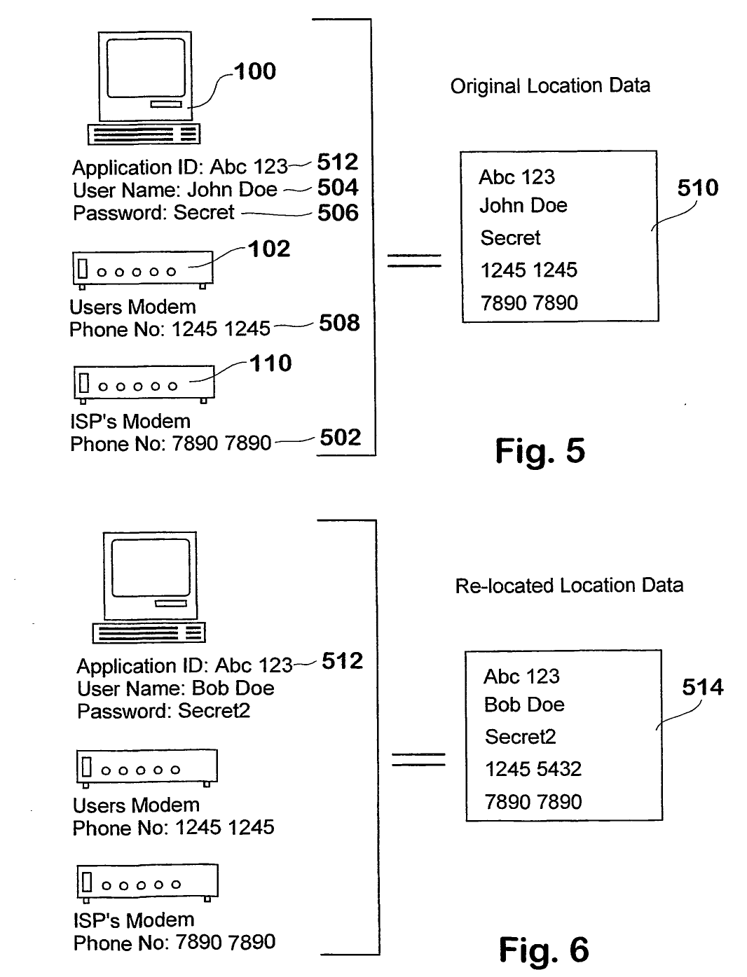

With reference now to FIG. 5, a computer 100 uses modem 102 to connect to the Internet via the ISP's modem 110. It will be noted that the user's modem contacts the ISP via connection number 502 and by doing so submits the user's user name 504, password 506, and telephone number 508. The identifiers may be collected to form a record 510 as shown.

As explained in further detail below, the present invention operates by installing a security program on the computer 100. It is possible to allocate a unique application ID 512 to each security program.

Suppose now that computer 100 is disconnected and moved to a remote location. For the computer to be reconnected to the Internet the new user may need to subscribe to his own ISP and enter the connection information in the same way as described above. In that case the computer may have associated with it, record of identifiers 514 in FIG. 6. It will be noted that while the computer identification codes i.e. the Application ID, have not changed the network location addresses, i.e. connection number and phone number, have indeed changed. Consequently, the data record 514 associated with the computer when connected to the new location contains some fields having values that differ from record 510. As will be explained, the present invention records changes such as those reflected in the differences between record 510 and record 514 in order to provide information as to the computer's present location.

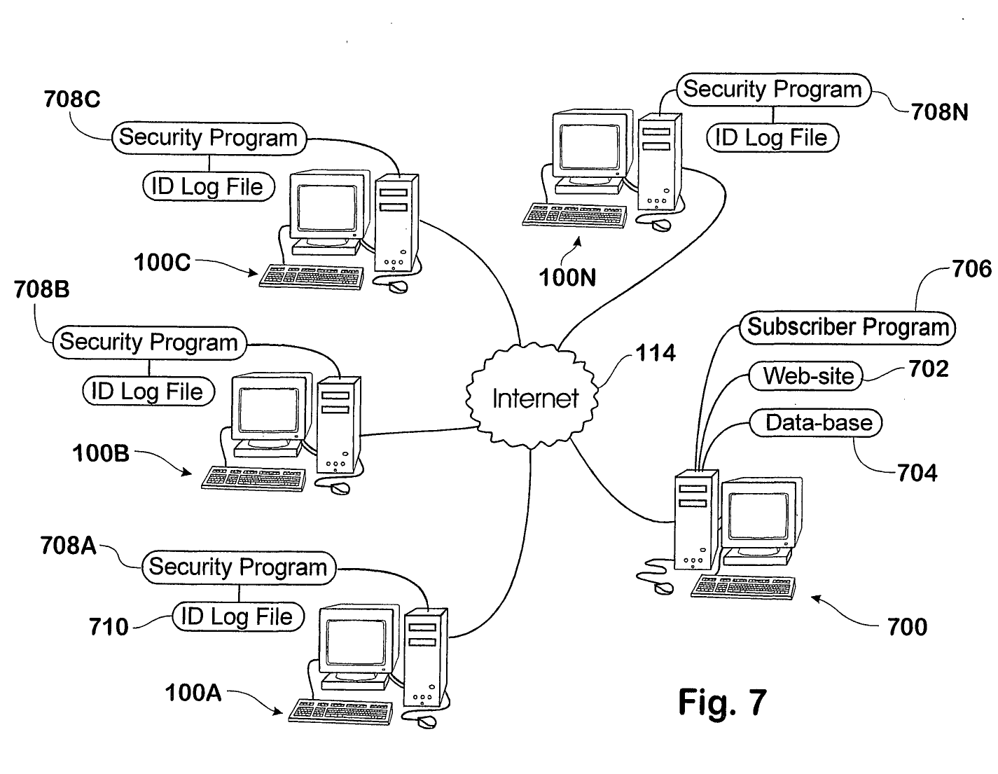

A system according to a first embodiment of the invention will now be described. With reference to FIG. 7, service computer 700 is loaded with software for providing a web-site 702. Computer 700 also maintains a database 704. The database containing a record for each computer 100A, . . . , 100N. The users of computers 100A, . . . , 100N are subscribers to a computer theft recovery service provided by the proprietor of computer 700. The fields of the database record are:

search key, such as the user name and password;

manufacturer's serial number;

network adaptor number;

local IP address;

router IP address;

IP address on data packet;

date and time of registration or most recent update to the record.

Service computer 700 is also loaded with a subscriber program 706 which when accessed by each of computers 100A, . . . , 100N installs a security program 708A, . . . , 708N on each computer respectively. It is also possible, with the cooperation of computer hardware manufacturers to install the security program into a non volatile memory (such as an EPROM) of the computer. This has the advantage of the security program being loaded, along with the operating system, each time the computer is switched on. As will be explained, the security program is comprised of instructions enabling the computer executing it to perform various tasks. The instructions referred to include:

location instructions by which the computer is able to determine computer identification codes, i.e. in this embodiment at least one of the computer's manufacturer serial number and the network adaptor number; and network location addresses, i.e. the computers local IP address and the router IP address to which it is connected;

transmission instructions enabling the computer to transmit the computer identification codes and the network location addresses over a computer network to a central service location for example to service computer 700;

logging instructions for generating a log of the computer's computer identification codes and network location address and storing the log file as a local file; and;

comparison instructions for comparing the log to the computer identification codes and network location addresses obtained by the location instructions.

As alluded to above, security program 708 contains instructions enabling each user to register their computer 100A, . . . , 100N with service computer 700 and to send messages to web-site 702 in order to update database 704 where relevant details change. For example, each of computers 100A, . . . , 100N contains a network card 302A, . . . , 302N respectively. In the event that the network card is changed then the address details of the new card may be sent to web-site 702 in order that database 704 may be updated appropriately.

The information that is stored in the database for a particular computer is also recorded in a log 710 generated by the logging instructions of security program 708.

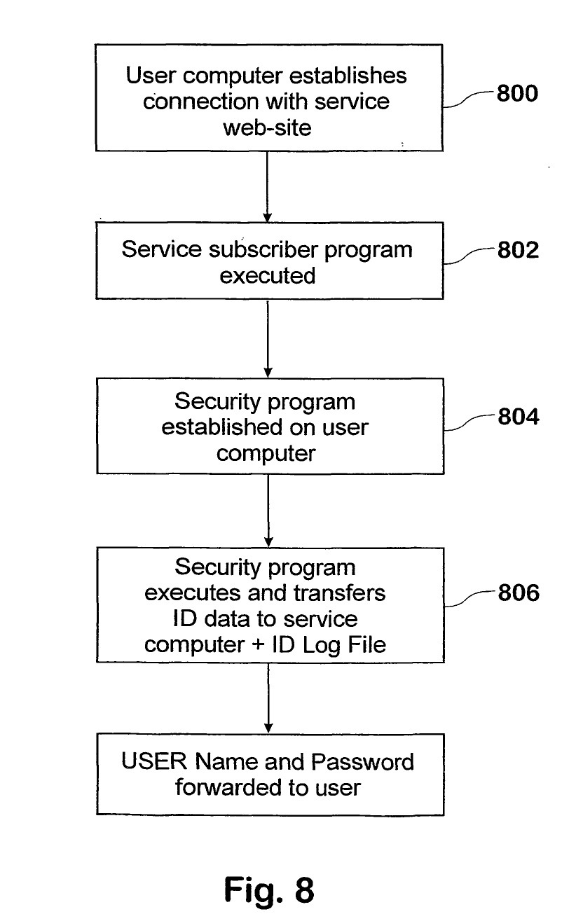

The process whereby a user registers their computer with the web site for the first time is described by reference to FIG. 8.

At box 800, a user of a computer 100 establishes connection with web-site 702 by the usual methods such as keying the URL of site 702 into an Internet browser loaded on computer 100.

At box 802, the user is prompted by web-site 702 to subscribe to the theft recovery service. If the user agrees to subscribe then they will be assigned a user name for the service and will be prompted to choose a password. A subscriber program 706 then commences execution so that, at box 804, security program 708 is installed on the user's computer. The security program has a unique software ID allocated, to distinguish it from the security program installed on a different subscribers computer.

At box 806, subsequent to its installation security program 706 executes the location instructions on computer 100 and determines computer 100's computer identification codes and network location addresses. Security program 706 then executes the transmission instructions and transmits the computer identification codes and network location addresses to web-site 702. Web-site 702 then creates a new record in database 704.

Finally, the logging instructions generate a log of the computer identification codes and the network location addresses and store the log as a local file on computer 100.

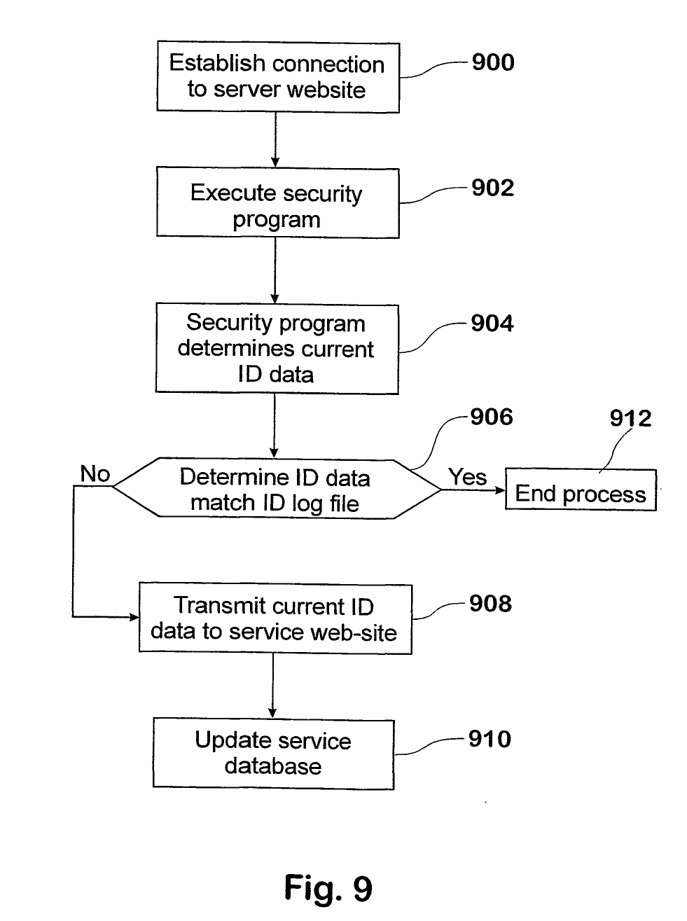

The updating of a record on the database is illustrated with reference to FIG. 9. At box 900 the user connects computer 100 to web-site 702 via the Internet.

At box 902 security program 706 commences execution. The activation of the security program occurs automatically upon establishment of a data connection with the Internet. Execution of security program 706 occurs without notification to a user of computer 100. Consequently an unauthorised user is not alerted to the existence or operation of the security program.

At box 904 the security program, by means of the location instructions, determines computer 100's computer identification codes and network location addresses.

At box 906 program 706 retrieves the log file 710 stored on computer 100 and, in accordance with the comparison instructions, compares the retrieved data with the user's current settings obtained by the location instructions. The current settings will include the local IP address of the computer has been allocated when connected at box 900 to the Internet.

If the current location address data differs from those recorded in log file 710, then the computer identification codes and network location addresses are transmitted, according to the transmission instructions, to web-site 702 which correspondingly updates database 704 at box 910.

In the event that a computer, for example computer 100 is stolen then it is likely that it will be transported from its present location to other premises and reconnected to the Internet by unauthorised persons for their illegitimate use.

Suppose that computer 100 has been illegitimately removed from its location on the Internet as shown in FIG. 3 and reconnected at another location as shown in FIG. 4. Note that the manufacturer's serial No. SG0907V-JVP-fff and network adaptor card address 00.30.5.7D.53.1 have not changed. Consequently the identity of the computer in question is established.

The data that has changed is as follows:

| | Original Location | New Location |
|---|---|---|
| IP Address | 203.10.255.15 | 203.4.224.202 |
| Router Address | 203.10.255.2 | 203.4.224.19 |
| Data Pkt Header | 203.10.255.2 | 203.4.224.19 |

In some cases the local IP address and router IP address determined by the location instructions will only be an “internal” address used to identify computers on a local area network. Accordingly, these addresses are of limited value in providing information as to the geographical location of a particular computer. The extraction of these types of addresses can occur, for example, where a computer is connected to a LAN via a wireless network adaptor card and/or when the LAN includes an internal router in addition to the external router that connects the LAN to the outside WAN.

The security program can be coded to include additional instructions to recognise that an “internal” IP address and/or router address has been determined by the location instructions. In the event that an “internal” address is recognised, the security program executes tracing instructions. The tracing instructions operate to determine the route that is taken by a network packet to reach a particular host.

The IP address of the service computer 700 could be used by the tracing program. The tracing program provides a list of hosts passed by the network packet on its route to the service computer.

In this embodiment of the invention the transmission instructions transmit the host list and the computer identification codes to the web site 702. The host list will include the IP address of the first “external” router that is passed by a network packet emanating from the computer 100 on its route to the web site.

In that event the owner of computer 100, in an attempt to gain information as to its new location, may log onto web-site 702, by means of another computer, and using their user name and password entry for computer 100 from database 704. The current entry will include the address of the router closest to the stolen computer being, in this example 203.4.224.19.

The above address may be entered into a database relating router address to geographical location. Such a database is available at the URL http://ipindex.dragonstar.net/index.html. Upon entering the IP Address 203.4.224.19 into the database the following type of information is returned

203.4.224.0-203.4.225.225 (STCNETWORK-AU) Silverton Technical College; 52 Robertson Street; South Kempsey; Vic 7121; AU.

That information can then be passed to law enforcement authorities in order to recover the computer in question.

Similarly, a large organisation could use the service to determine where a particular computer has been connected to the Internet if that computer has been misplaced within the organisation.

A system according to a second embodiment of the invention will now be described. With reference again to FIG. 7 the fields of the database record are:

search key, such as the user name and password

ISP user name

ISP password

ISP connection phone number

ISP alternate connection phone number

user phone number

ID number

It is to be understood that the terms ISP user name, ISP password, ISP connection number, ISP alternative connection number are the details entered by the user when establishing a connection to the Internet through their ISP. It is to be contrasted with the user name and password used for the theft recovery service.

Suppose the computer 100 has been illegitimately removed from its location on the Internet as shown in FIG. 5 and reconnected at another location as in FIG. 6. Note that the ID number has not changed since it is stored as a part of the security program, which is still installed on the computer 100. Consequently, again the identity of the computer in question is established. The data that has changed is as follows:

| | Original Location | New Location |
|---|---|---|
| User Name | John Doe | Jane Doe |
| Password | Secret | Secret 2 |
| Original Modem number | 12451245 | 14545432 |
| Telephone number | 87918791 | 45674567 |
| ID number | 78907890 | 7890 7890 |

In that event the owner of computer 100, in an attempt to gain. information as to its new location may again log onto web site 702 and retrieve the current entry for computer 100 from database 704. The current entry will include the phone number dialed by the user's modem to connect to the ISP. It will also include the home telephone number of the new user of the computer. These numbers and particularly the home telephone number can be provided to law enforcement authorities in order to retrieve the computer in question. The home address of the user, and accordingly the location of the computer, can be easily determined from the telephone number by means available to law enforcement authorities. Additionally, the telephone number dialled by the user's modem to connect to the ISP can be used to obtain information as to the identity of the ISP. The ISP could then be contacted by law enforcement authorities in order to obtain details as to the particular subscriber identified by their user name and password.

The above described embodiments of the invention are intended to be examples of the present invention and alterations and modifications may be effected thereto, by those of skill in the art, without departing from the scope of the invention which is defined solely by the claims appended hereto.

I claim:

1. A method for determining the network location of a plurality of user computers connected to a computer network, the method comprising the steps of:
making available for installation on each of said user computers, a software product comprising:
location instructions for determining at least one computer identification code and at least one network location address of the user computer;
logging instructions for generating a log of said at least one computer identification code and network location address;
comparison instructions for comparing the log to current network location addresses associated with a further connection to the computer network; and
transmission instructions for transmitting the computer identification code and the current network location address to a central service location in the event of a discrepancy between the log and the current network location address;
maintaining a record of network location addresses and computer identification codes transmitted to the central service location for each user computer; and
providing from the central service location at least one network location address in response to a search key submitted by a user.

2. The method of claim 1 wherein the computer network is a local area network.

3. The method of claim 1 wherein the computer network is a wide area network.

4. The method of claim 1 wherein the computer network is the Internet.

5. The method of claim 1 wherein the user computer is a personal computer.

6. The method of claim 5 wherein the personal computer is a laptop computer.

7. The method of claim 5 wherein the personal computer is a personal digital assistant.

8. The method of claim 1 wherein the computer identification code comprises any one or more of a manufacturers serial number, a network adaptor identifier, and a unique identification code allocated to the installed software product.

9. The method of claim 1 wherein the network location address comprises any one or more of a local IP address, a router IP address, and an IP address on data packet.

10. The method of claim 1 wherein the network location address is an ISP connection phone number and a user telephone number.

11. The method of claim 1 wherein the network location address comprises an ISP user name, an ISP password and an ISP connection phone number.

12. The method of claim 1 wherein the central service location is a remote world wide web server.

13. The method of claim 1 wherein the search key is a user password related in the record to the computer identification code.

14. The method of claim 1 wherein the transmission instructions also transmit the time and date of the further connection to the computer network.

15. The method of claim 14 wherein the time and date of the further connection to the computer network is provided from the central service location to a user with the network location address.

16. The method of claim 1 wherein the software product comprises:
recognition instructions for recognising if the network location addresses determined by the location instructions is not indicative of the network location of the user computer; and
tracing instructions for generating a list of network location addresses of hosts visited by a network packet enroute from said user computer to a specified destination host, wherein said list is transmitted by the transmission instructions with the computer identification codes to the central service location.

17. The method of claim 16 wherein the destination host is the central service location.

18. A software product stored upon a computer readable medium for execution by a computer, the software product comprising:
location instructions for determining at least one computer identification code and at least one network location address for the computer when connected to a computer network;
logging instructions for generating a log of at least one computer identification code and network location address;
comparison instructions for comparing the log to current network location addresses associated with a further connection to the computer network; and
transmission instructions for transmitting the computer identification code and network location address to a central service location in the event of a discrepancy between the log and the current network location address.

19. The software product of claim 18 wherein the computer network is a local area network.

20. The software product of claim 18 wherein the computer network is a wide area network.

21. The software product of claim 18 wherein the computer network is the Internet.

22. The software product of claim 18 wherein the computer is a personal computer.

23. The software product of claim 22 wherein the personal computer is a laptop computer.

24. The software product of claim 22 wherein the personal computer is a personal digital assistant.

25. The software product of claim 18 wherein the computer identification code comprises any one or more of a manufacturer's serial number, a network adaptor identifier, and a unique identification code allocated to an installed software product.

26. The software product of claim 18 wherein the network location address comprises any one or more of a local IP address, a router IP address, and an IP address on data packet.

27. The software product of claim 18 wherein the network location address is an ISP connection phone number or a user telephone number.

28. The software product of claim 18 wherein the network location address comprises an ISP user name, an ISP password and an ISP connection phone number.

29. The software product of claim 18 wherein the central service location is a remote world wide web server.

30. The software product of claim 18 where the transmission instructions also transmit the time and date of the current connection to the computer network.

31. The software product of claim 30 wherein the date and time of the further connection to the computer network is provided from the central service location to a user with the network location address.

32. The software product of claim 18 wherein the software product comprises:
recognition instructions for recognising if the network location address determined by the location instructions is not indicative of the network location of the computer; and
tracing instructions for generating a list of network location addresses of hosts visited by a network packet enroute from said user computer to a specified destination host, and wherein said list is transmitted by the transmission instructions with the computer identification codes to the central service location.

33. The software product of claim 31 wherein the destination host is the central service location.

34. A method of determining the network location of a plurality of user computers connected to a computer network, the method comprising the steps of:
making available for installation on each of said user computers a software product comprising:
location instructions for determining at least one computer identification code and at least one network location address of the user computer;
logging instructions for generating a log of said at least one computer identification code and network location address;
comparison instructions for comparing the log to current network location addresses associated with a further connection to the computer network;
tracing instructions for generating a list of network location addresses of hosts visited by a network packet enroute from a current network location address to the network location address of a specified destination host; and
transmission instructions for transmitting the computer identification code and the list of network location addresses to a central service location in the event of a discrepancy between the log and the current network location address;
maintaining a record of network location addresses and computer identification codes transmitted to the central service location for each user computer; and
providing from the central service location at least one network location address in response to a search key submitted by a user.

35. The method of claim 34 wherein the computer is a local area network.

36. The method of claim 34 wherein the computer network is a wide area network.

37. The method of claim 34 wherein the computer network is the Internet.

38. The method of claim 34 wherein the user computer is a personal computer.

39. The method of claim 38 wherein the personal computer is a laptop computer.

40. The method of claim 38 wherein the personal computer is a personal digital assistant.

41. The method of claim 34 wherein the computer identification code comprises any one or more of a manufacturers serial number, a network adaptor identifier, and a unique identification code allocated to the installed software product.

42. The method of claim 34 wherein the network location address is a local IP address.

43. The method of claim 34 wherein the network location address is a router IP address.

44. The method of claim 34 wherein the central service location is a remote world wide web server.

45. The method of claim 34 wherein the destination host is the central service location.

46. The method of claim 34 wherein the search key is a user password related in the record to the computer identification code.

47. A software product stored upon a computer readable medium for execution by a computer, the software product comprising:
location instructions for determining at least one computer identification code and at least one network location address of the user computer;
logging instructions for generating a log of said at least one computer identification code and network location address;
comparison instructions for comparing the log to current network location addresses associated with a further connection to the computer network;
tracing instructions for generating a list of network location addresses of hosts visited by a network packet enroute from a current network location address to the network location address of a specified destination host; and
transmission instructions for transmitting the computer identification code and the list of network location addresses to a central service location in the event of a discrepancy between the log and the current network location address;

48. The software product of claim 47 wherein the computer network is a local area network.

49. The software product of claim 47 wherein the computer network is a wide area network.

50. The software product of claim 47 wherein the computer network is the Internet.

51. The software product of claim 47 wherein the user computer is a personal computer.

52. The software product of claim 51 wherein the personal computer is a laptop computer.

53. The software product of claim 51 wherein the user computer is a personal digital assistant.

54. The software product of claim 47 wherein the computer identification code comprises any one or more of a manufacturers serial number, a network adaptor identifier, and a unique identification code allocated to the installed software product.

55. The software product of claim 47 wherein the network location address is a local IP address.

56. The software product of claim 47 wherein the network location address is a router IP address.

57. The software product of claim 47 wherein the central service location is a remote world wide web server.

58. The software product of claim 47 wherein the destination host is the central service location.
